(19) United States
(12) Patent Application Publication
(10) Pub. No.: US 2006/0045511 A1
(43) Pub. Date: Mar. 2, 2006

(54) Wafer dividing method

(75) Inventor: Satoshi Genda, Tokyo (JP)

Correspondence Address: SMITH, GAMBRELL & RUSSELL, LLP, 1850 M STREET, N.W., SUITE 800, WASHINGTON, DC, 20036, US

(73) Assignee: Disco Corporation

(21) Appl. No.: 11/211,696

(22) Filed: Aug. 26, 2005

(30) Foreign Application Priority Data
Sep. 1, 2004 (JP) 2004-253791

(51) Int. Cl. G03B 7/26

(52) U.S. Cl. 396/205

(57) ABSTRACT

A method of dividing a wafer having a plurality of streets formed on the front surface in a lattice pattern, devices formed in a plurality of areas sectioned by the plurality of streets, and a metal film formed on the back surface, into individual chips, comprising: a street cutting step for cutting the front surface of the wafer along the streets to form grooves, leaving an uncut portion having a predetermined thickness on the back surface side; and a cutting-off step for cutting off the uncut portion and the metal film by applying a laser beam to the uncut portion of the groove formed along the streets.

### FIELD OF THE INVENTION

The present invention relates to a method of dividing a wafer having a plurality of streets formed in a lattice pattern on the front surface, circuits formed in a plurality of areas sectioned by the plurality of streets and a metal film formed on the back surface, into individual chips.

### DESCRIPTION OF THE PRIOR ART

In the production process of a semiconductor device, for example, individual semiconductor chips are manufactured by forming a circuit such as IC or LSI in a plurality of areas sectioned by cutting lines called “streets” formed in a lattice pattern on the front surface of a substantially disk-like semiconductor wafer and cutting the semiconductor wafer into the areas having the circuit formed thereon, along the streets. A cutting machine as disclosed by JP-A 2001-85365 is generally used as the dividing machine for dividing the semiconductor wafer. This cutting machine cuts the semiconductor wafer along the streets with a cutting blade as thick as about 20 to 40 μm.

Meanwhile, a wafer having a plurality of devices such as power transistors or the like on the front surface has a film of a metal such as gold, silver or titanium having a thickness of several tens of nm, on the back surface as an earth.

When the wafer whose back surface is coated with a metal film is cut with the cutting blade of the cutting machine, the following problems arise. That is, since the metal film formed on the back surface of the wafer has tackiness, when the wafer is cut with the cutting blade, burrs are produced at the periphery of the back surface of each of the obtained chips or chippings are produced on both sides of a groove on the back surface of the chip. Further, since the cutting blade cuts the wafer together with the metal film, chippings of the metal film adhere to the cutting blade, thereby causing clogging to reduce the service life of the cutting blade.

### SUMMARY OF THE INVENTION

It is an object of the present invention to provide a wafer dividing method capable of dividing a wafer having a metal film formed on the back surface without producing burrs or chippings on the back surface and without causing the clogging of a cutting blade.

According to the present invention, the above object can be attained by a method of dividing a wafer having a plurality of streets formed on the front surface in a lattice pattern, devices formed in a plurality of areas sectioned by the plurality of streets and a metal film coated on the back surface, into individual chips, comprising:

a street cutting step for cutting the front surface of the wafer along the streets to form grooves, leaving an uncut portion having a predetermined thickness on the back surface side; and

a cutting-off step for cutting off the uncut portion and the metal film by applying a laser beam to the uncut portion of the groove formed along the streets.

The uncut portion is set to 5 to 20 μm in thickness. Preferably, a wafer supporting step of putting the metal film side of the wafer on a dicing tape mounted on an annular frame is carried out before the above street cutting step.

In the present invention, since in the street cutting step, the groove is formed, it leaving an uncut portion on the back surface side of the wafer, chippings are not produced on both sides of the grooves. Further, since the metal film formed on the back surface of the wafer is not cut in the street cutting step, the metal film does not adhere to the cutting blade, thereby making it possible to prevent the clogging of the cutting blade by the adhesion of the metal film.

### BRIEF DESCRIPTION OF THE DRAWINGS

FIG. 1 is a perspective view of a semiconductor wafer to be divided by the wafer dividing method of the present invention;

FIG. 2 is an explanatory diagram showing the wafer supporting step in the wafer dividing method of the present invention;

FIGS. 3(a) and 3(b) are explanatory diagrams showing the street cutting step in the wafer dividing method of the present invention;

FIGS. 4(a) and 4(b) are explanatory diagrams showing the cutting step in the wafer dividing method of the present invention; and

FIG. 5 is a perspective view of a semiconductor chip divided by the wafer dividing method of the present invention.

### DETAILED DESCRIPTION OF THE PREFERRED EMBODIMENT

A preferred embodiment of the present invention will be described in detail with reference with the accompanying drawings.

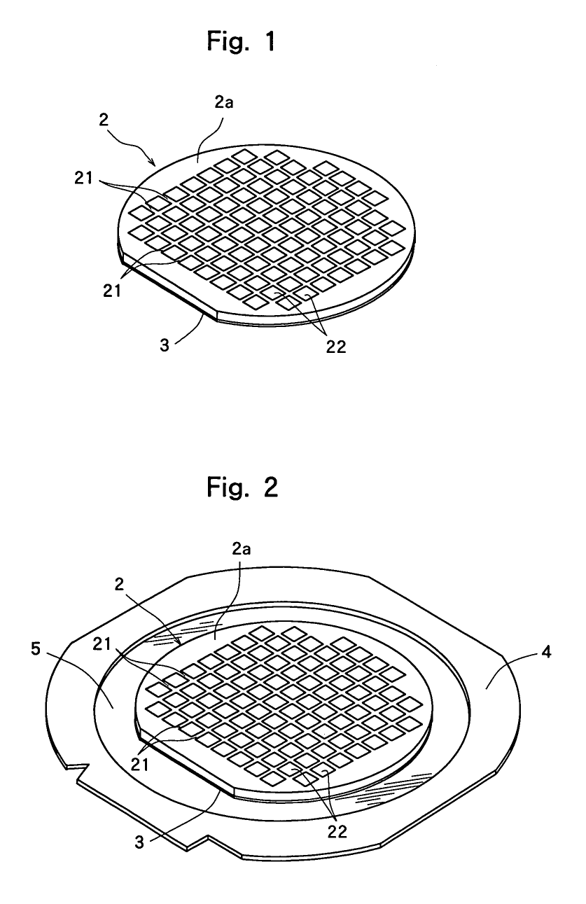

FIG. 1 is a perspective view of a semiconductor wafer to be divided according to the present invention. In the semiconductor wafer 2 shown in FIG. 1, a plurality of streets 21 are formed in a lattice pattern on the front surface 2a of a silicon substrate having a thickness of, for example, 600 μm and a device 22 such as a circuit is formed in each of a plurality of areas sectioned by the plurality of streets 21. The back surface 2b of the semiconductor wafer 2 is coated with a metal film 3 such as a gold, silver or titanium film having a thickness of several tens of nm.

To divide the above semiconductor wafer 2 into individual semiconductor chips, a wafer supporting step of putting the metal film 3 side of the semiconductor wafer 2 having the metal film 3 formed on the back surface 2b, on a dicing tape mounted on an annular frame is carried out. That is, as shown in FIG. 2, the metal film 3 side of the semiconductor wafer 2 having the metal film 3 affixed to the back surface 2b is put on the surface of the dicing tape 4 such as a polyolefin sheet or the like, that is mounted on the annular support frame 4 to cover its inner opening portion.

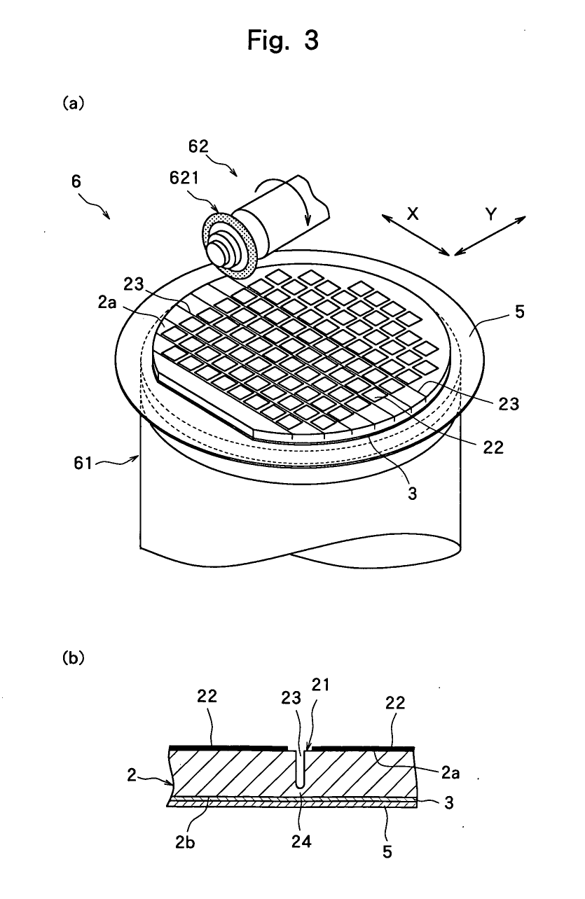

Next comes the street cutting step of cutting the front surface 2a of the semiconductor wafer 2 on the dicing tape 5 along the streets 21 to form grooves, leaving an uncut portion having a predetermined thickness on the back surface 2b side. This street cutting step can be carried out by using a cutting machine 6 that is generally used as a dicing machine as shown in FIG. 3(a). The cutting machine 6 has a chuck table 61 having a suction-holding means and a cutting means 62 having a cutting blade 621. The semiconductor wafer 2 is placed on the chuck table 61 of the cutting machine 6 in such a manner that the front surface 2a of the semiconductor wafer 2 faces up (the dicing tape 5 faces down) and suction-held on the chuck table 61 by activating a suction means that is not shown. Although the annular support frame 4, on which the dicing tape 5 is mounted, is not shown in FIG. 3(a), the support frame 4 is held on a suitable frame holding means. After the semiconductor wafer 2 is thus held on the chuck table 61, the chuck table 61 is fed in a direction indicated by an arrow X, while the cutting blade 621 of the cutting means 62 is rotated, to form a groove 23 along a street 21 extending in a predetermined direction. This groove 23 leaving an uncut portion 24 having a predetermined thickness on the back surface 2b side of the semiconductor wafer 2 is formed, as shown in FIG. 3(b). The suitable thickness of the uncut portion 24 is 5 to 20 μm.

After the groove 23 is thus formed along the street 21 extending in the predetermined direction, the cutting means 62 is indexing-fed by a distance corresponding to the interval between the streets 21, in a direction indicated by an arrow Y, and the above cutting-feed is carried out again. After the above cutting-feed and indexing-feed are carried out on all the streets extending in the predetermined direction, the chuck table 61 is turned at 90° to carry out the above cutting-feed and indexing-feed along streets extending in a direction perpendicular to the above predetermined direction, whereby the groove 23 is formed along all the streets 21 formed on the semiconductor wafer 2.

Since in the street cutting step, the grooves 23 leaving the uncut portion 24 on the back surface 2b side of the semiconductor wafer 2 are formed as described above, chippings are not produced on both sides of the grooves 23. Further, since the metal film 3 affixed to the back surface 2b of the semiconductor wafer 2 is not cut in the street cutting step, the metal film 3 does not adhere to the cutting blade 621, thereby making it possible to prevent the clogging of the cutting blade 621 by the adhesion of the metal film 3.

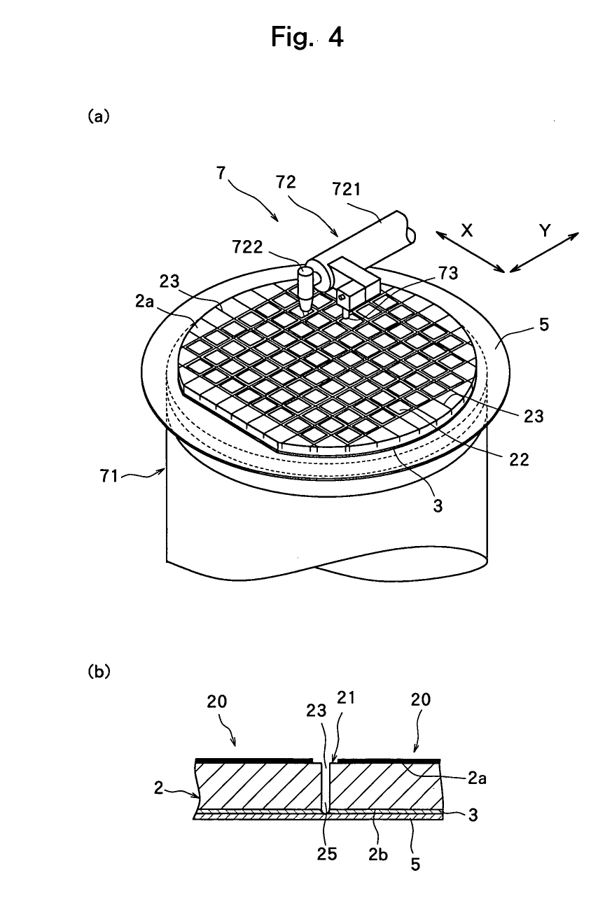

After the above street cutting step, next comes a cutting-off step of cutting off the uncut portion 24 and the metal film 3 by applying a laser beam to the uncut portion of the groove 23 formed along the streets 21 of the semiconductor wafer 2. This cutting-off step is carried out by using a laser beam machine 7 as shown in FIG. 4(a). The laser beam machine 7 shown in FIG. 4(a) comprises a chuck table 71 having a suction-holding means, a laser beam application means 72 for applying a laser beam to a workpiece held on the chuck table 71, and an image pick-up means 73 for picking up an image of the workpiece held on the chuck table 71. The chuck table 71 is so constituted as to suction-hold the workpiece and is designed to be moved in a processing-feed direction indicated by an arrow X and in an indexing-feed direction indicated by an arrow Y in FIG. 4(a) by a moving mechanism that is not shown. The above laser beam application means 72 has a cylindrical casing 721 arranged substantially horizontally, and applies a pulse laser beam from a condenser 722 attached to the end of the above casing 721.

The semiconductor wafer 2 which has been subjected to the above street cutting step is placed on the chuck table 71 of this laser beam machine 7 in such a manner that the front surface 2a thereof faces up (i.e., the dicing tape 5 faces down), and suction-held on the chuck table 71 by activating the suction means that is not shown. Although the annular support frame 4, on which the dicing tape 5 is mounted, is omitted in FIG. 4(a), the support frame 4 is supported on a suitable frame holding means. After the semiconductor wafer 2 is thus held on the chuck table 71, the chuck table 71 is activated in the direction indicated by the arrow X to bring the semiconductor wafer 2 to a position right below the image pick-up means 73. Then, image processing such as pattern matching, etc., for aligning a groove 23 formed along a street 21 of the semiconductor wafer 2 with the laser beam application means 72 is carried out by the image pick-up means 73 and a control means (not shown) to perform the alignment of a laser beam application position.

After the alignment of the laser beam application position is thus carried out, the chuck table 71 is moved to a laser beam application area where the laser beam application means 72 is located, and is processing-fed in the direction indicated by the arrow X at a predetermined rate (50 to 200 mm/sec.) while the laser beam is applied toward the uncut portion 24 of the groove 23 from the condenser 722. As a result, as shown in FIG. 4(b), a laser processed groove 25 is formed in the uncut portion 24 of the groove 23 formed in the semiconductor wafer 2 to cut the semiconductor wafer 2, and the metal film 3 is also molten and cut. The laser beam applied in the above cutting step is the following ultraviolet laser beam, for example.
Laser: YVO4 pulse laser
Wavelength: 355 nm
Repetition frequency: 50 KHz
Average output: 1.0 to 4.0 W
Pulse width: 10 to 100 ns
Focusing spot diameter: 10 to 25 μm

After the laser beam is applied to the uncut portion 24 of the groove 23 formed along the street 21 extending in the predetermined direction of the semiconductor wafer 2 to cut the uncut portion 24 and the metal film 3 off as described above, the chuck table 71 or the laser beam application means 72 is moved by a distance corresponding to the interval between the streets 21 in the indexing direction indicated by the arrow Y to carry out the above processing-feed again while the laser beam is applied. After the above processing-feed and indexing-feed are carried out on the uncut portions 24 of the grooves 23 formed along all the streets 21 extending in the predetermined direction, the chuck table 71 is turned at 90° to carryout the above processing-feed and indexing-feed on the uncut portions 24 of the grooves 23 formed along the streets 21 extending in a direction perpendicular to the above predetermined direction, whereby the semiconductor wafer 2 is divided into individual semiconductor chips 20 having the metal film 3 formed on the back surface 2b.

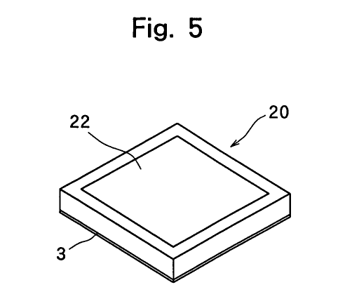

The semiconductor chips 20 individually divided by the above cutting-off step are carried to a pick-up step in a state where they are put on the top surface of the dicing tape 5 mounted on the support frame 4. In the pick-up step, the individually separated semiconductor chips 20 are removed from the dicing tape 5 to obtain a semiconductor chip having the metal film 3 formed on its back surface, as shown in FIG. 5.

What is claimed is:

1. A method of dividing a wafer having a plurality of streets formed on the front surface in a lattice pattern, devices formed in a plurality of areas sectioned by the plurality of streets, and a metal film coated on the back surface, into individual chips, comprising:
a street cutting step for cutting the front surface of the wafer along the streets to form grooves, leaving an uncut portion having a predetermined thickness on the back surface side; and
a cutting-off step for cutting off the uncut portion and the metal film by applying a laser beam to the uncut portion of the groove formed along the streets.

2. The wafer dividing method according to claim 1, wherein the uncut portion is set to 5 to 20 μm in thickness.

3. The wafer dividing method according to claim 1, wherein a wafer supporting step of putting the metal film side of the wafer on a dicing tape mounted on an annular frame is carried out before the street cutting step.
